(19) United States
(12) Patent Application Publication
(10) Pub. No.: US 2026/0221478 A1
(43) Pub. Date: Jul. 30, 2026

(54) METHODS FOR MANUFACTURING MEMBRANE ELECTRODE ASSEMBLY FOR A PROTON EXCHANGE MEMBRANE ELECTROCHEMICAL CELL

(71) Applicant: GM Global Technology Operations LLC, Detroit, MI (US)

(72) Inventor: Swaminatha P. KUMARAGURU, Rochester Hills, MI (US)

(21) Appl. No.: 19/041,652

(22) Filed: Jan. 30, 2025

(51) Int. Cl. H01M 8/1004; C25B 9/23; C25B 11/032; C25B 11/089; C25B 13/08; H01M 4/86; H01M 4/92; H01M 8/1032; H01M 8/1039; H01M 8/10

(52) U.S. Cl. CPC H01M 8/1004; C25B 9/23; C25B 11/032; C25B 11/089; C25B 13/08; H01M 4/8605; H01M 4/8657; H01M 4/8663; H01M 4/921; H01M 8/1032; H01M 8/1039; H01M 2008/1095; H01M 2300/0082

(57) ABSTRACT

A method for manufacturing a membrane electrode assembly for an electrochemical cell includes providing a first substrate including a first film coated from one or more polymeric materials; coating a first electrode on the first substrate; coating a membrane layer on the first electrode; providing a second substrate including a second film coated from one or more polymeric materials; coating a second electrode on the second substrate; arranging a sub-gasket between and in contact with a periphery of the membrane layer and the second electrode; hot pressing the second electrode to the membrane layer with the sub-gasket at least partially arranged between the second electrode and the membrane layer; and removing the first substrate and the second substrate.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to membrane electrode assemblies, and more particularly to membrane electrode assemblies for fuel cells and electrolysis cells.

Fuel cells can be used to provide power to a load. Fuel cells include anode electrodes, cathode electrodes, and a polymer electrolyte membrane (PEM). The polymer electrolyte membrane is arranged between the cathode and anode electrodes. Molecular hydrogen (H₂) is supplied to the anode electrode and molecular oxygen (O₂) is supplied to the cathode electrode. Hydrogen ions (H⁺) pass through the PEM. Electrons (e⁻) pass through an external circuit such as a load producing current through the load. Fuel cells can be used to supply power to electric vehicles and/or for stationary applications.

Electrolysis cells can be used to split water (H₂O) into molecular hydrogen (H₂) and molecular oxygen (O₂). Water electrolysis cells include anode electrodes, cathode electrodes, and a polymer electrolyte membrane (PEM). The polymer electrolyte membrane is arranged between the cathode and anode electrodes. The PEM allows protons to pass through while keeping the gases separate.

Fuel cells or electrolysis cells using the PEM or other anion exchange membrane fuel cells and/or electrolyzers typically include gaskets and frames to support fluid flow. The gaskets and frames also provide a seal to restrict flows to their respective regions.

### SUMMARY

A method for manufacturing a membrane electrode assembly for an electrochemical cell includes providing a first substrate including a first film coated from one or more polymeric materials; coating a first electrode on the first substrate; coating a membrane layer on the first electrode; providing a second substrate including a second film coated from one or more polymeric materials; coating a second electrode on the second substrate; arranging a sub-gasket between and in contact with a periphery of the membrane layer and the second electrode; hot pressing the second electrode to the membrane layer with the sub-gasket at least partially arranged between the second electrode and the membrane layer; and removing the first substrate and the second substrate.

In other features, the first electrode is a cathode electrode comprising one of an oxygen reduction reaction (ORR) and a hydrogen evolution reaction (HER) catalyst selected from a group consisting of platinum and a platinum alloy and the second electrode is an anode electrode comprising one of a hydrogen oxidation reaction (HOR) and a oxygen evolution reaction (OER) catalyst selected from a group consisting of platinum, palladium, iridium, and ruthenium.

In other features, the first electrode is an anode electrode comprising one of a hydrogen oxidation reaction (HOR) and an oxygen evolution reaction (OER) catalyst selected from a group consisting of platinum, palladium, iridium, and ruthenium and the second electrode is a cathode electrode comprising one of an oxygen reduction reaction (ORR) and a hydrogen evolution reaction (HER) catalyst selected from a group consisting of platinum and a platinum alloy.

In other features, the membrane layer comprises an ion conducting polymer selected from a group consisting of perfluoro sulfonic acid (PFSA) and a non PFSA ionomer. The membrane layer comprises a recombination catalyst selected from a group consisting of platinum, palladium, a radical scavenger selected from a group of cerium, manganese containing compounds, and combinations thereof. In certain embodiments, the membrane layer comprises a polymeric reinforcement such as expanded polytetrafluroethylene.

In other features, the membrane electrode assembly comprises an electrolysis cell and further comprising a porous transport layer arranged adjacent to one of the first electrode and the second electrode and a gas diffusion layer adjacent to the other of the first electrode and the second electrode.

In other features, the membrane electrode assembly comprises a fuel cell and further comprising a first gas diffusion layer arranged adjacent to the first electrode and a second gas diffusion layer adjacent to the second electrode.

A method for manufacturing a membrane electrode assembly for an electrochemical cell includes providing a first substrate including a first film coated from one or more polymeric materials; coating a first electrode on the first substrate; coating a first membrane layer on the first electrode; providing a second substrate including a first film coated from one or more polymeric materials; coating a second electrode on the second substrate; coating a second membrane layer on the second electrode; arranging a sub-gasket between and in contact with a periphery of the first membrane layer and the second membrane layer; and hot pressing the first membrane layer against the second membrane layer with the sub-gasket arranged at least partially therebetween.

In other features, the first electrode is a cathode electrode comprising one of an oxygen reduction reaction (ORR) and a hydrogen evolution reaction (HER) catalyst selected from a group consisting of platinum and a platinum alloy and the second electrode is an anode electrode comprising one of a hydrogen oxidation reaction (HOR) and an oxygen evolution reaction (OER) catalyst selected from a group consisting of platinum, palladium, iridium, and ruthenium.

In other features, the first electrode is an anode electrode comprising one of a hydrogen oxidation reaction (HOR) and a oxygen evolution reaction (OER) catalyst selected from a group consisting of platinum, palladium, iridium, and ruthenium and the second electrode is a cathode electrode comprising one of an oxygen reduction reaction (ORR) and a hydrogen evolution reaction (HER) catalyst selected from a group consisting of platinum and a platinum alloy.

In other features, the first and second membrane layer comprises an ion conducting polymer selected from a group consisting of perfluoro sulfonic acid (PFSA) and a non PFSA ionomer. The first membrane layer comprises a recombination catalyst selected from a group consisting of platinum, palladium, a radical scavenger selected from a group of cerium, manganese containing compounds, and combinations thereof. In certain embodiments, either or both membrane layer comprises a polymeric reinforcement such as expanded polytetrafluroethylene (ePTFE).

In other features, the membrane electrode assembly comprises an electrolysis cell and further comprising a porous transport layer arranged adjacent to one of the first electrode and the second electrode and a gas diffusion layer adjacent to the other of the first electrode and the second electrode.

In other features, the membrane electrode assembly comprises a fuel cell and further comprising a first gas diffusion layer arranged adjacent to the first electrode; and a second gas diffusion layer adjacent to the second electrode.

A method for manufacturing a membrane electrode assembly for an electrochemical cell includes providing a first substrate including a first film coated from one or more polymeric materials; coating a first electrode on the first substrate; coating a first membrane layer on the first electrode; and coating a second electrode on one of the first membrane layer and a second membrane layer coated on the first membrane layer. The method includes removing the first substrate and applying a first gasket and a second gasket on a periphery of an outer surface of the first electrode and the second electrode.

In other features, the first electrode is a cathode electrode comprising one of an oxygen reduction reaction (ORR) and a hydrogen evolution reaction (HER) catalyst selected from a group consisting of platinum and a platinum alloy and the second electrode is an anode electrode comprising one of a hydrogen oxidation reaction (HOR) and an oxygen evolution reaction (OER) catalyst selected from a group consisting of platinum, palladium, iridium, and ruthenium.

In other features, the first electrode is an anode electrode comprising one of a hydrogen oxidation reaction (HOR) and an oxygen evolution reaction (OER) catalyst selected from a group consisting of platinum, palladium, iridium, and ruthenium and the second electrode is a cathode electrode comprising one of an oxygen reduction reaction (ORR) and a hydrogen evolution reaction (HER) catalyst selected from a group consisting of platinum and a platinum alloy.

In other features, the first and second membrane layer comprises an ion conducting polymer selected from a group consisting of perfluoro sulfonic acid (PFSA) and a non PFSA ionomer. The first membrane layer comprises a recombination catalyst selected from a group consisting of platinum, palladium, a radical scavenger selected from a group of cerium, manganese containing compounds, and combinations thereof. In certain embodiments, either or both membrane layer comprises a polymeric reinforcement such as expanded polytetrafluroethylene (ePTFE).

In other features, the membrane electrode assembly comprises an electrolysis cell and further comprising a porous transport layer arranged adjacent to one of the first electrode and the second electrode and a gas diffusion layer adjacent to the other of the first electrode and the second electrode.

In other features, the membrane electrode assembly comprises a fuel cell. A first gas diffusion layer arranged adjacent to the first electrode. A second gas diffusion layer adjacent to the second electrode.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a cross section of an example of a fuel cell according to the present disclosure;

FIG. 1B is a cross section of an example of an electrolysis cell according to the present disclosure;

FIG. 2A is a plan view of an example of an anode decal according to the present disclosure;

FIG. 2B is a plan view of an example of an anode electrode coated on the anode decal according to the present disclosure;

FIG. 2C is a plan view of an example of a membrane layer coated on the anode electrode according to the present disclosure;

FIG. 2D is a plan view of an example of a sub-gasket according to the present disclosure;

FIG. 2E is a plan view of an example of a cathode decal according to the present disclosure;

FIG. 2F is a plan view of an example of a cathode electrode coated on the cathode decal according to the present disclosure;

FIG. 2G is a side view of an example of a membrane electrode assembly according to the present disclosure;

FIG. 3A is a plan view of an example of an anode decal according to the present disclosure;

FIG. 3B is a plan view of an example of an anode electrode coated on the anode decal according to the present disclosure;

FIG. 3C is a plan view of an example of a membrane layer coated on the anode electrode according to the present disclosure;

FIG. 3D is a plan view of an example of a sub-gasket according to the present disclosure;

FIG. 3E is a plan view of an example of a cathode decal according to the present disclosure;

FIG. 3F is a plan view of an example of a cathode electrode coated on the cathode decal according to the present disclosure;

FIG. 3G is a plan view of an example of a membrane layer coated on the cathode electrode according to the present disclosure;

FIG. 3H is a side view of another example of a membrane electrode assembly according to the present disclosure;

FIG. 4A is a plan view of an example of an anode decal according to the present disclosure;

FIG. 4B is a plan view of an example of an anode electrode coated on the anode decal according to the present disclosure;

FIG. 4C is a plan view of an example of a membrane layer coated on the anode electrode according to the present disclosure;

FIG. 4D is a plan view of an example of a cathode electrode coated on the membrane layer according to the present disclosure;

FIGS. 4E and 4F are plan views of examples of gaskets; and

FIG. 4G is a side view of another example of a membrane electrode assembly according to the present disclosure.

In the drawings, reference numbers may be reused to identify similar and/or identical elements.

### DETAILED DESCRIPTION

A membrane electrode assembly (MEA) for proton exchange membrane (PEM) fuel cells and electrolysis cells has been manufactured using a catalyst coated on membrane approach. In this approach, both anode electrodes and cathode electrodes are coated on a polymer film (also referred to as a decal film). Similarly, the membrane is coated onto a decal film, and the anode and cathode electrodes are transferred to the membrane. This method of manufacturing the MEA is costly due to the number of steps including cutting, transferring, and laminating.

A method for manufacturing the membrane electrode assembly (MEA) according to the present disclosure for a PEM fuel cells and/or electrolysis cells uses a roll-to-roll multilayer coating approach. In some examples, a first electrode layer is coated on a first polymeric film (or decal film) followed by coating a first membrane layer on the first electrode layer. A second polymeric film (or decal film) is coated with a second electrode layer. The first membrane layer and the second electrode layer are hot pressed against each other with a sub-gasket arranged at periphery of and between the first membrane layer and the second electrode layer.

In some examples, the plastic decal is provided in a roll form. Electrodes and membranes are coated in a continuous roll-to-roll process. The coated electrode or electrode-membrane multilayers are cut into sheets before lamination.

In other examples, a first electrode layer is coated on a first polymeric film (or decal film) followed by coating a first membrane layer on the first electrode layer. A second polymeric film (or decal film) is coated with a second electrode layer followed by coating a second membrane layer on the second electrode layer. The first and second membrane layers are hot pressed against each other with a sub-gasket arranged at periphery of and between the first and second membrane layers.

In other examples, a first electrode layer is coated on a first polymeric film (or decal film) followed by coating a first membrane layer on the first electrode layer. A second membrane layer is coated on the first membrane layer. A second electrode layer is coated on the second membrane layer. The first polymeric film is removed and first and second gasket films are applied on an outer periphery of outer surfaces of the first electrode and the second electrode.

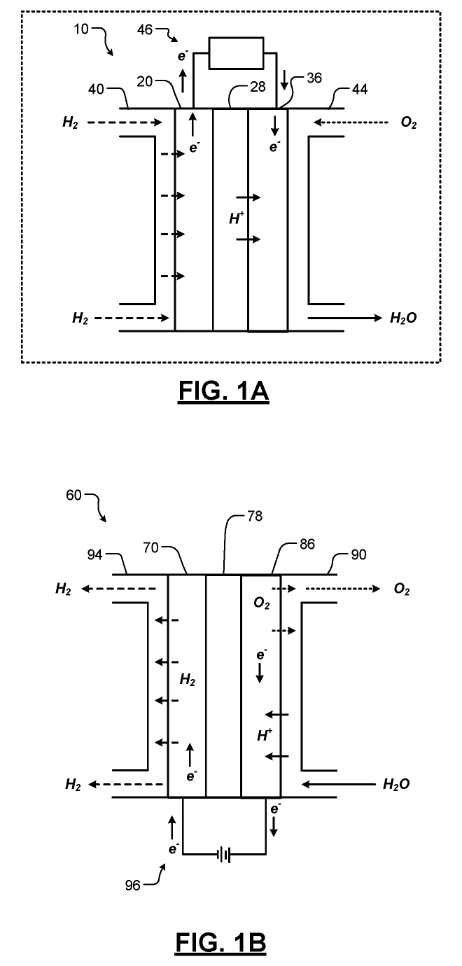

Referring now to FIG. 1A, a fuel cell 10 includes an anode electrode 20, a membrane 28, and a cathode electrode 36. Gas diffusion layers 40 and 44 are arranged adjacent to the anode electrode 20 and the cathode electrode 36, respectively. Molecular hydrogen (H₂) is supplied to the gas diffusion layer 40 of the anode electrode 20. Molecular oxygen (O₂) is supplied to the gas diffusion layer 44 of the cathode electrode 36. A hydrogen oxidation reaction (HOR) occurs at the anode electrode 20, hydrogen gas (H2) is split in to protons (H+) and electrons (e-). The membrane 28 passes hydrogen ions (H⁺) to the cathode electrode 36. Electrons (e-) pass through an external circuit 46 such as a load or battery to the cathode electrode. A oxygen reduction reaction (ORR) occurs at the cathode electrode 36, molecular oxygen (O₂), hydrogen ions (H⁺) and electode (e-) react to form water (H₂O).

Cathode (reduction): 2H⁺ + 2e⁻ +1/2 O₂(g) →H₂O(l); and

Anode (oxidation): H₂(g) →2 H⁺ + 2e⁻.

Overall: 2H₂(g) + O₂(g) →2H₂O(l)

Referring now to FIG. 1B, an electrolysis cell 60 includes a cathode electrode 70, a membrane 78, and an anode electrode 86. A porous transport layer (PTL) 90 is arranged adjacent to the anode electrode 86. A gas diffusion layer 94 is arranged adjacent to the cathode electrode 70. Water (H₂O) is supplied to the porous transport layer (PTL) 90. A power source 96 supplies power across the cathode electrode 70 and the anode electrode 86.

A reduction reaction, hydrogen evolution reaction (HER) takes place at the cathode electrode 70 . Electrons (e⁻) from external power supply combine with hydrogen cations (H⁺) to form molecular hydrogen (H₂). At the anode electrode 86 , an oxidation reaction, oxygen evolution reaction (OER) occurs which generates molecular oxygen gas and supplies electrons to the cathode electrode 86 to complete the circuit. The two half-reactions (e.g., reduction and oxidation) are coupled to form a balanced system. For example, the half-reactions may include:

Cathode (reduction): 2H⁺(aq) + 2e⁻→H₂(g); and

Anode (oxidation): H₂O(l)→1/2 O₂(g) + 2 H⁺(aq) + 2e⁻.

Overall: 2H₂O(l) → 2H₂(g) + O₂(g)

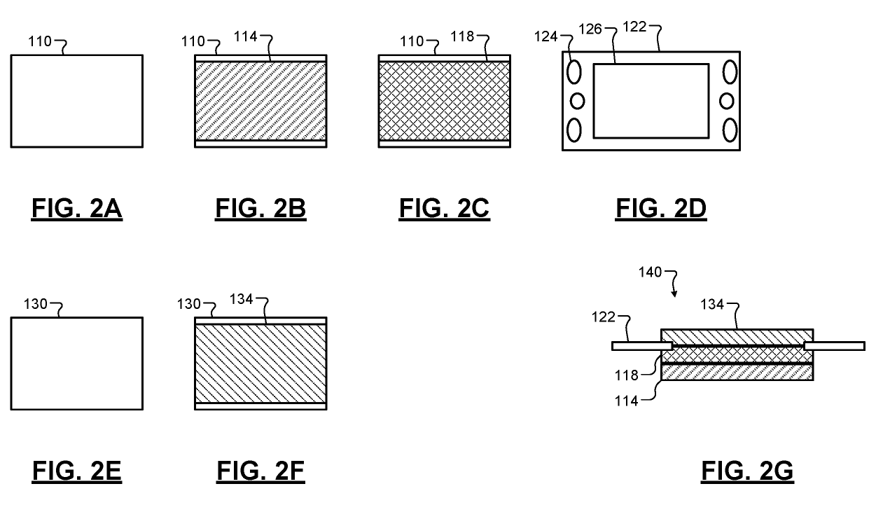

Referring now to FIGS. 2A to 2G, a method for manufacturing the membrane electrode assembly for a fuel cell or electrolysis cell is shown. In FIG. 2A, an anode decal 110 is shown. In FIG. 2B, an anode electrode 114 is coated on the anode decal 110. In FIG. 2C, a membrane layer 118 is coated on the anode electrode 114. In FIG. 2D, a sub-gasket 122 including outer ports 124 and a central opening 126 is shown.

In FIG. 2E, a cathode decal 130 is shown. In FIG. 2F, a cathode electrode 134 is coated on the cathode decal 130. In FIG. 2G, a membrane electrode assembly is shown at 140. The sub-gasket 122 is arranged between the cathode electrode 134 and the membrane layer 118. In some examples, the cathode (or anode) electrode is hot pressed against the membrane layer 118 with the sub-gasket 122 positioned in between. The sub-gasket 122 overlaps at a periphery of the cathode (or anode) electrode and the membrane layer 118. As can be appreciated, the locations of the anode and cathode electrodes can be switched.

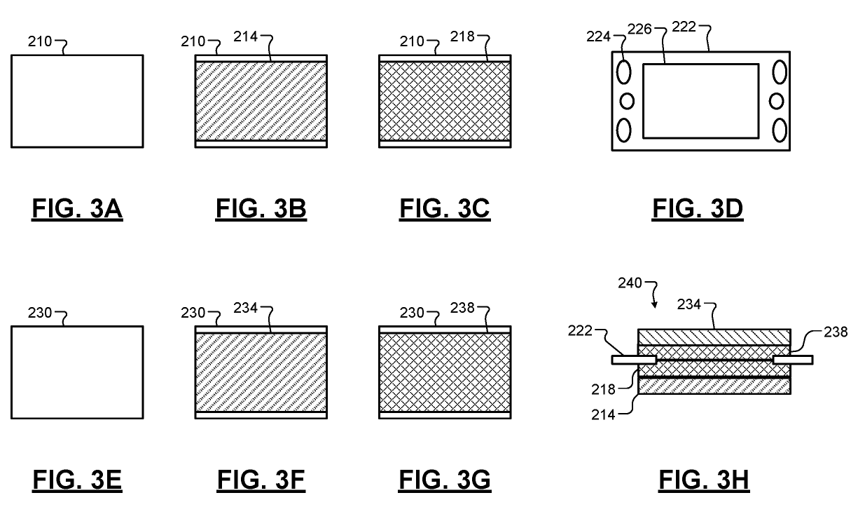

Referring now to FIGS. 3A to 3G, another method for manufacturing the membrane electrode assembly for a fuel cell or electrolysis cell is shown. In FIG. 3A, an anode decal 210 is shown. In FIG. 3B, an anode electrode 214 is coated on the anode decal 210. In FIG. 3C, a membrane layer 218 is coated on the anode electrode 214. In FIG. 3D, a gasket 222 including outer ports 224 and a central opening 226 is shown.

In FIG. 3E, a cathode decal 230 is shown. In FIG. 3F, a cathode electrode 234 is coated on the cathode decal 230. In FIG. 3C, a membrane layer 238 is coated on the cathode electrode 234. In FIG. 3G, a membrane layer 238 is coated on the cathode electrode 234.

In FIG. 3H, a membrane electrode assembly is shown at 240. The sub-gasket 222 is arranged at outer peripheries of and between the membrane layer 218 and the membrane layer 238. As can be appreciated, the locations of the anode and cathode electrodes can be switched.

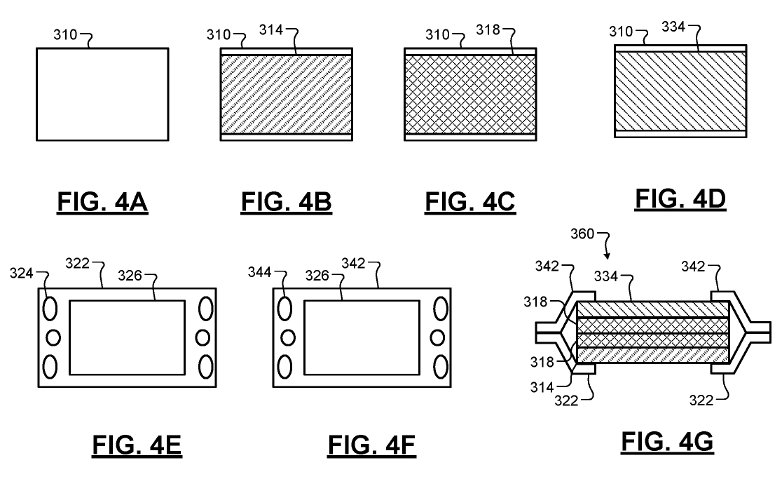

Referring now to FIGS. 4A to 4G, another method for manufacturing the membrane electrode assembly for a fuel cell or electrolysis cell is shown. In FIG. 4A, an anode decal 310 is shown. In FIG. 4B, an anode electrode 314 is coated on the anode decal 310. In FIG. 4C, a membrane layer 318 is coated on the anode electrode 314. In FIG. 4D, a cathode electrode 334 is coated on the membrane layer 318. In FIGS. 4E and 4F, gaskets 322 and 342 including outer ports 324 and 344, and central openings 326 and 346, respectively, are shown.

In FIG. 4G, a membrane electrode assembly 360 is shown. The gaskets 322 and 342 are arranged on outer surfaces of the anode electrode 314 and the cathode electrode 334. As can be appreciated, the locations of the anode and cathode electrodes can be switched.

In some examples, the anode and cathode decals include a polymeric film material selected from a group consisting of polyethylene terephthalate, poly tetrafluoroethylene, polyimide, and/or combinations thereof.

In some examples, the membrane layers are applied as a single layer or multiple layers. In some examples, the membrane layer comprises an ion conducting polymer. In some examples, the ion conducting polymer is selected from a group consisting of perfluoro sulfonic acid (PFSA) and a non-PFSA ionomers. In some examples, the non-PFSA ionomer is selected from a group consisting of PEMION^{TM}, poly benzo imidazole, or other suitable non-PFSA ionomers.

In some examples, the membrane layer comprises a recombination catalyst selected from a group consisting of platinum, palladium, a radical scavenger (cerium cations, manganese cations, etc.), and combinations thereof. In some examples, the membrane layer includes reinforcement such as expanded polytetrafluoroethylene (ePTFE).

In some examples, the anode electrode includes a hydrogen oxidation reaction (HOR) or oxygen evolution reaction (OER) catalyst selected from a group consisting of platinum, palladium, iridium, and ruthenium. In some examples, the cathode electrode includes a oxygen reduction reaction (ORR) or hydrogen evolution reaction (HER) catalyst selected from a group consisting of platinum and platinum alloys (e.g., platinum cobalt (PtCo), platinum nickel (PtNi), etc.).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A method for manufacturing a membrane electrode assembly for an electrochemical cell, the method comprising:
providing a first substrate including a first film coated from one or more polymeric materials;
coating a first electrode on the first substrate;
coating a membrane layer on the first electrode;
providing a second substrate including a second film coated from one or more polymeric materials;
coating a second electrode on the second substrate;
arranging a sub-gasket between and in contact with a periphery of the membrane layer and the second electrode;
hot pressing the second electrode to the membrane layer with the sub-gasket at least partially arranged between the second electrode and the membrane layer; and
removing the first substrate and the second substrate.

2. The method of claim 1, wherein the first electrode is a cathode electrode comprising one of an oxygen reduction reaction (ORR) and a hydrogen evolution reaction (HER) catalyst selected from a group consisting of platinum and a platinum alloy and the second electrode is an anode electrode comprising one of a hydrogen oxidation reaction (HOR) and a oxygen evolution reaction (OER) catalyst selected from a group consisting of platinum, palladium, iridium, and ruthenium.

3. The method of claim 1, wherein the first electrode is an anode electrode comprising one of a hydrogen oxidation reaction (HOR) and an oxygen evolution reaction (OER) catalyst selected from a group consisting of platinum, palladium, iridium, and ruthenium and the second electrode is a cathode electrode comprising one of an oxygen reduction reaction (ORR) and a hydrogen evolution reaction (HER) catalyst selected from a group consisting of platinum and a platinum alloy.

4. The method of claim 1, wherein the membrane layer comprises an ion conducting polymer selected from a group consisting of perfluoro sulfonic acid (PFSA), a non PFSA ionomer. and a polymeric reinforcement material.

5. The method of claim 1, wherein the membrane layer comprises a recombination catalyst selected from a group consisting of platinum, palladium, a radical scavenger selected from a group of cerium, manganese containing compounds, and combinations thereof.

6. The method of claim 1, wherein the membrane electrode assembly comprises an electrolysis cell and further comprising:
a porous transport layer arranged adjacent to one of the first electrode and the second electrode; and
a gas diffusion layer adjacent to the other of the first electrode and the second electrode.

7. The method of claim 1, wherein the membrane electrode assembly comprises a fuel cell and further comprising:
a first gas diffusion layer arranged adjacent to the first electrode; and
a second gas diffusion layer adjacent to the second electrode.

8. A method for manufacturing a membrane electrode assembly for an electrochemical cell, the method comprising:
providing a first substrate including a first film coated from one or more polymeric materials;
coating a first electrode on the first substrate;
coating a first membrane layer on the first electrode;
providing a second substrate including a first film coated from one or more polymeric materials;
coating a second electrode on the second substrate;
coating a second membrane layer on the second electrode;
arranging a sub-gasket between and in contact with a periphery of the first membrane layer and the second membrane layer; and
hot pressing the first membrane layer against the second membrane layer with the sub-gasket arranged at least partially therebetween.

9. The method of claim 8, wherein the first electrode is a cathode electrode comprising one of an oxygen reduction reaction (ORR) and a hydrogen evolution reaction (HER) catalyst selected from a group consisting of platinum and a platinum alloy and the second electrode is an anode electrode comprising one of a hydrogen oxidation reaction (HOR) and an oxygen evolution reaction (OER) catalyst selected from a group consisting of platinum, palladium, iridium, and ruthenium.

10. The method of claim 8, wherein the first electrode is an anode electrode comprising one of a hydrogen oxidation reaction (HOR) and a oxygen evolution reaction (OER) catalyst selected from a group consisting of platinum, palladium, iridium, and ruthenium and the second electrode is a cathode electrode comprising one of an oxygen reduction reaction (ORR) and a hydrogen evolution reaction (HER) catalyst selected from a group consisting of platinum and a platinum alloy.

11. The method of claim 8, wherein the first membrane layer comprises an ion conducting polymer selected from a group consisting of perfluoro sulfonic acid (PFSA), a non PFSA ionomer, and a polymeric reinforcement material.

12. The method of claim 8, wherein the first membrane layer comprises a recombination catalyst selected from a group consisting of platinum, palladium, a radical scavenger selected from a group of cerium, manganese containing compounds, and combinations thereof.

13. The method of claim 8, wherein the membrane electrode assembly comprises an electrolysis cell and further comprising:
a porous transport layer arranged adjacent to one of the first electrode and the second electrode; and
a gas diffusion layer adjacent to the other of the first electrode and the second electrode.

14. The method of claim 8, wherein the membrane electrode assembly comprises a fuel cell and further comprising:
a first gas diffusion layer arranged adjacent to the first electrode; and
a second gas diffusion layer adjacent to the second electrode.

15. A method for manufacturing a membrane electrode assembly for an electrochemical cell, the method comprising:
providing a first substrate including a first film coated from one or more polymeric materials;
coating a first electrode on the first substrate;
coating a first membrane layer on the first electrode;
coating a second electrode on one of:
the first membrane layer; and
a second membrane layer coated on the first membrane layer;
removing the first substrate; and
applying a first gasket and a second gasket on a periphery of an outer surface of the first electrode and the second electrode.

16. The method of claim 15, wherein one of:
the first electrode is a cathode electrode comprising one of an oxygen reduction reaction (ORR) and a hydrogen evolution reaction (HER) catalyst selected from a group consisting of platinum and a platinum alloy and the second electrode is an anode electrode comprising one of a hydrogen oxidation reaction (HOR) and an oxygen evolution reaction (OER) catalyst selected from a group consisting of platinum, palladium, iridium, and ruthenium; and
the first electrode is an anode electrode comprising one of a hydrogen oxidation reaction (HOR) and an oxygen evolution reaction (OER) catalyst selected from a group consisting of platinum, palladium, iridium, and ruthenium and the second electrode is a cathode electrode comprising one of an oxygen reduction reaction (ORR) and a hydrogen evolution reaction (HER) catalyst selected from a group consisting of platinum and a platinum alloy.

17. The method of claim 15, wherein the first membrane layer comprises an ion conducting polymer selected from a group consisting of perfluoro sulfonic acid (PFSA), a non PFSA ionomer, and a polymeric reinforcement material.

18. The method of claim 15, wherein the first membrane layer comprises a recombination catalyst selected from a group consisting of platinum, palladium, a radical scavenger selected from a group of cerium, manganese containing compounds, and combinations thereof.

19. The method of claim 15, wherein the membrane electrode assembly comprises an electrolysis cell and further comprising:
a porous transport layer arranged adjacent to one of the first electrode and the second electrode; and
a gas diffusion layer adjacent to the other of the first electrode and the second electrode.

20. The method of claim 15, wherein the membrane electrode assembly comprises a fuel cell and further comprising:
a first gas diffusion layer arranged adjacent to the first electrode; and
a second gas diffusion layer adjacent to the second electrode.
